(19) United States
(12) Patent Application Publication
(10) Pub. No.: US 2023/0101184 A1
(43) Pub. Date: Mar. 30, 2023

(54) COLUMN INVERSION DRIVING CIRCUIT AND DISPLAY PANEL

(71) Applicant: Wuhan China Star Optoelectronics Technology Co., Ltd., Wuhan, Hubei (CN)

(72) Inventors: Sha LIU, Wuhan, Hubei (CN); Lin ZHANG, Wuhan, Hubei (CN); Junhui GUO, Wuhan, Hubei (CN)

(73) Assignee: Wuhan China Star Optoelectronics Technology Co., Ltd., Wuhan, Hubei (CN)

(21) Appl. No.: 16/961,952

(22) PCT Filed: May 18, 2020
(86) PCT No.: PCT/CN2020/090767

§ 371 Date: Jul. 14, 2020

(30) Foreign Application Priority Data
Mar. 27, 2020 (CN) 202010231204.1

(51) Int. Cl. G09G 3/20

(52) U.S. Cl. CPC G09G 3/2003; G09G 2300/0823; G09G 2310/0297; G09G 2330/021

(57) ABSTRACT

An embodiment of the present invention provides a column inversion driving circuit. The column inversion driving circuit could reduce the voltage level of the logic low of the n^{th} impulse signal, which is used to control the n^{th} TFT matrix, through the cooperation of the voltage level of the n^{th} impulse signal and the n^{th} positive data signal. Furthermore, the voltage level of the logic high of the (n+1)^{th} impulse signal, which is used to control the (n+1)^{th} TFT matrix, is also reduced through the cooperation of the voltage level of the (n+1)^{th} impulse signal and the (n+1)^{th} negative data signal. This reduces the power consumption of the column inversion driving circuit.

### TECHNICAL FIELD

The present invention relates to a display technique, and more particularly, to a column inversion driving technique. Specifically, the present invention relates to a column inversion driving circuit and a display panel.

### BACKGROUND

As the resolution increase of the display, the data lines in the panel for connecting the data driver chip become more and more. Correspondingly, the number of pins of the data driver chips becomes larger as well. In this way, the size of the data driver chip needs to be larger or the number of the data driver chips needs to be larger. However, both of these do not help the narrow side frame design. In order to realize the full-screen design and increase the screen-to-body ratio, the number of the data lines should be reduced. Therefore, conventionally, a MUX control circuit is inserted between the data driver chip and the data lines. For example, one data line could be connected to n sub-pixels (n=1, 2, 3, 4, 5, 6 or etc.) through the MUX control circuit. This is called as MUX1:n. In this way, the number of the data lines could be reduced to 1/n of the original number. For example, assume one data line is connected to three or six sub-pixels, which is called as MUX1:3 or MUX1:6. Then, the number of the data lines could be reduced to ⅓ or ⅙ of the original number. This reduces the size and layout space of the data driver chip and thus also reduces the size of the side frame of the display.

However, in the above example of MUX1:n, the power consumption is increased because the MUX control circuit, in addition to the data driver chip, the gate driver on array (GOA) circuit, needs to consume power. Conventionally, the switching frequency of the output signal of the MUX control circuit, which is for switching between the turn-on voltage and the turn-off voltage, is very fast and thus the MUX control circuit consumes a huge amount of power. In addition, as the increase of resolution and refreshing frequency, the power consumption of the MUX control circuit will be increased accordingly.

### SUMMARY

### Technical Solution

One objective of an embodiment of the present invention is to provide a column inversion driving circuit and a display panel, to solve the above-mentioned issue of the MUX control circuit, which introduces a huge power consumption when the MUX control circuit outputs the output signal to control the on/off states of the thin film transistors (TFTs).

According to an embodiment of the present invention, a column inversion driving circuit is disclosed. The column inversion driving circuit comprises at least one column inversion driving unit, wherein a n^{th} column inversion unit comprises a n^{th} TFT matrix and a (n+1)^{th} TFT matrix. A source of the n^{th} TFT matrix is electrically connected to a n^{th} column positive data signal, a gate of the n^{th} TFT matrix is electrically connected to a n^{th} impulse signal set, and a drain of the n^{th} TFT matrix is electrically connected to a corresponding sub-pixel of an odd column. A source of the (n+1)^{th} TFT matrix is electrically connected to a (n+1)^{th} column negative data signal, a gate of the (n+1)^{th} TFT matrix is electrically connected to a (n+1)^{th} impulse signal set, and a drain of the (n+1)^{th} TFT matrix is electrically connected to a corresponding sub-pixel of an even column. A voltage level of a logic low of the n^{th} impulse signal set is higher than a turn-off voltage of the n^{th} TFT matrix, a voltage level of a logic high of the (n+1)^{th} impulse signal set is lower than a turn-on voltage of the (n+1)^{th} TFT matrix, and the (n+1)^{th} TFT matrix comprises a plurality of n-channel TFTs.

Optionally, the n^{th} TFT matrix comprises a first TFT, a second TFT, and a third TFT. The n^{th} column positive data signal is electrically connected to a source of the first TFT, a source of the second TFT and a source of the third TFT; the n^{th} impulse signal set is electrically connected to a gate of the first TFT, a gate of the second TFT and a gate of the third TFT; a drain of the first TFT is electrically connected to a n^{th} sub-pixel of an odd column; a drain of the second TFT is electrically connected to a (n+1)^{th} sub-pixel of an odd column, and a drain of the third TFT is electrically connected to a (n+2)^{th} sub-pixel of an odd column.

Optionally, the n^{th} impulse signal set comprises a first impulse signal, a second impulse signal and a third impulse signal. The first impulse signal is electrically connected to the gate of the first TFT, the second impulse signal is electrically connected to the gate of the second TFT, and the third impulse signal is electrically connected to the gate of the third TFT.

Optionally, a voltage level of a logic low of the first impulse signal is higher than a turn-off voltage of the first TFT, a voltage level of a logic low of the second impulse signal is higher than a turn-off voltage of the second TFT, and a voltage level of a logic low of the third impulse signal is higher than a turn-off voltage of the third TFT.

Optionally, the (n+1)^{th} TFT matrix comprises a fourth TFT, a fifth TFT, and a sixth TFT. The (n+1)^{th} column negative data signal is electrically connected to a source of the fourth TFT, a source of the fifth TFT, and a source of the sixth TFT; the (n+1)^{th} impulse signal set is electrically connected to a gate of the fourth TFT, a gate of the fifth TFT, and a gate of the sixth TFT; a drain of the fourth TFT is electrically connected to a n^{th} sub-pixel of an even column; a drain of the fifth TFT is electrically connected to a (n+1)^{th} sub-pixel of an even column; and a drain of the sixth TFT is electrically connected to a (n+2)^{th} sub-pixel of an even column.

Optionally, the (n+1)^{th} impulse signal set comprises a fourth impulse signal, a fifth impulse signal and a sixth impulse signal. The fourth impulse signal is electrically connected to the gate of the fourth TFT, the fifth impulse signal is electrically connected to the gate of the fifth TFT, and the sixth impulse signal is electrically connected to the gate of the sixth TFT.

Optionally, a voltage level of a logic high of the fourth impulse signal is lower than a turn-on voltage of the fourth TFT, a voltage level of a logic high of the fifth impulse signal is lower than a turn-on voltage of the fifth TFT, and a voltage level of a logic high of the sixth impulse signal is lower than a turn-on voltage of the sixth TFT.

Optionally, the n^{th} TFT matrix comprises a plurality of n-channel TFTs.

Optionally, the (n+1)^{th} TFT matrix comprises a plurality of n-channel TFTs.

According to an embodiment of the present invention, a display panel is disclosed. The display panel comprises the above-mentioned column inversion driving circuit, a data driver and a data selector. The data selector is configured to provide the above-mentioned n^{th} column positive data signal and the above-mentioned (n+1)^{th} column negative data signal, and the data selector is configured to provide the above-mentioned n^{th} impulse signal set and the above-mentioned (n+1)^{th} impulse signal set.

### Advantageous Effect

An embodiment of the present invention provides a column inversion driving circuit. The column inversion driving circuit could reduce the voltage level of the logic low of the n^{th} impulse signal, which is used to control the n^{th} TFT matrix, through the cooperation of the voltage level of the n^{th} impulse signal and the n^{th} positive data signal. Furthermore, the voltage level of the logic high of the (n+1)^{th} impulse signal, which is used to control the (n+1)^{th} TFT matrix, is also reduced through the cooperation of the voltage level of the (n+1)^{th} impulse signal and the (n+1)^{th} negative data signal. This reduces the power consumption of the column inversion driving circuit.

### BRIEF DESCRIPTION OF THE DRAWINGS

FIG. 1a is a diagram of a conventional MUX1:3 circuit.

FIG. 1b is a diagram of charging the positive data voltage in the MUX1:3 circuit shown in FIG. 1a.

FIG. 1c is a diagram of charging the negative data voltage in the MUX1:3 circuit shown in FIG. 1a.

FIG. 2 is a diagram of a conventional MUX1:6 circuit

FIG. 3 is a diagram of a column inversion driving circuit according to an embodiment of the present invention.

FIG. 4 is a diagram of a column inversion driving circuit according to another embodiment of the present invention.

FIG. 5a is a diagram showing the operations of the column inversion driving circuit according to an embodiment of the present invention.

FIG. 5b is a diagram of charging the positive data voltage in the column inversion driving circuit shown in FIG. 5a.

FIG. 5c is a diagram of charging the negative data voltage in the column inversion driving circuit shown in FIG. 5a.

FIG. 6a is a diagram of the first impulse signal set when the column inversion driving circuit performs the column inversion.

FIG. 6b is a diagram of the second impulse signal set when the column inversion driving circuit performs the column inversion.

FIG. 7 is a diagram of a display panel according to an embodiment of the present invention.

### DETAILED DESCRIPTION OF PREFERRED EMBODIMENTS

For the purpose of description rather than limitation, the following provides such specific details as a specific system structure, interface, and technology for a thorough understanding of the application. However, it is understandable by persons skilled in the art that the application can also be implemented in other embodiments not providing such specific details. In other cases, details of a well-known apparatus, circuit and method are omitted to avoid hindering the description of the application by unnecessary details. In order to clearly illustrate the purpose, technique and advantage of the present invention, the MUX1:3 pixel charging mechanism is used as an example.

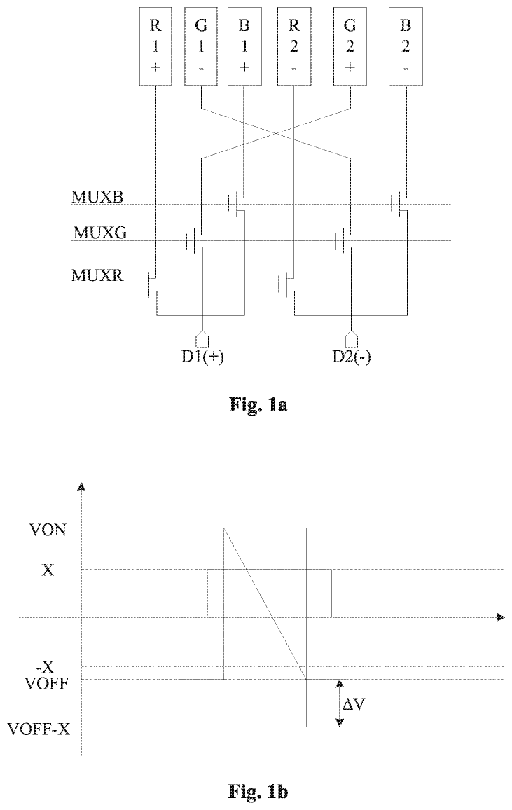

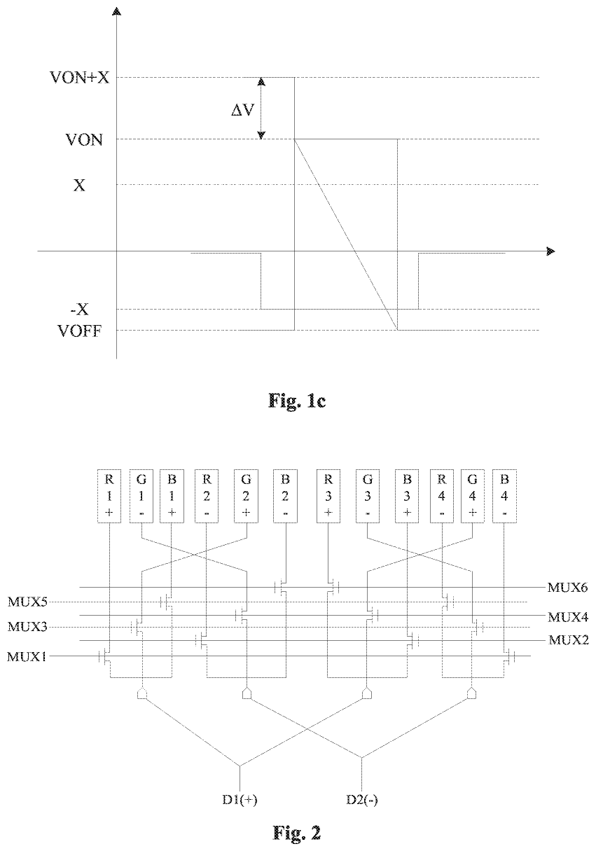

Please refer to FIG. 1a. MUXR, MURG, and MURB respectively represent the MUX control signal lines corresponding to R, G, B sub-pixels. D1 and D2 are data signals. MUX transistors are turned on or off to control the transmission of the data signals (data voltages). In this case, the column inversion mechanism is adopted. In the m^{th} frame, when D1 transmits a positive data voltage, the adjacent D2 transmits a negative data voltage. Thus, the column of sub-pixels R1 correspond to the positive data voltage, the column of sub-pixels G1 corresponds to the negative data voltage, the column of sub-pixels B1 corresponds to the positive data voltage, and so on. In the (m+1)^{th} frame, the polarities are inversed. When the column of gates are turned on (column scan signal corresponds to the high voltage level), the data lines, controlled by the MUXR, MUXG, and MUXB, charges the R, G, and B sub-pixels at different time. The MUXR, MUXG, and MUXB are turned on in an order. Only when the gate and the MUXR are simultaneously turned on, the data line D1 changes the R1. When the gate and the MUXG are simultaneously turned on, the data line D1 changes the G1. When the gate and the MUXB are simultaneously turned on, the data line D1 changes the B1. Therefore, the switching frequency of the MUX is three times of the switching frequency of the gate. MUX1:n circuit has a similar operation, which means that the switching frequency of the MUX is n times of the switching frequency of the gate.

Please refer to FIG. 1b. FIG. 1b is a diagram of charging the positive data voltage in the MUX1:3 circuit shown in FIG. 1a. VON is the turn-on voltage of the transistor. VOFF is the turn-off voltage of the transistor. That is, the MUX control signal needs to be periodically switched between VON and VOFF to turn on/turn off the transistor. X is the voltage of the data line D1. The gate of the transistor is connected to the MUX control signal line. The source of the transistor represents an end having a lower voltage level. Vgs is the voltage difference between the gate and the source of the transistor. At the time when the MUX transistor is being turned on, Vgs is equal to VON. At the time when the MUX transistor is being turned off, Vgs is equal to the absolute value of VOFF−X (VOFF is a negative value). Therefore, the negative voltage level outputted by the MUX control signal is much lower than turn-off threshold value VOFF of the transistor. The voltage difference ΔV=X is wasted.

Please refer to FIG. 1c. FIG. 1c is a diagram of charging the negative data voltage in the MUX1:3 circuit shown in FIG. 1a. −X is the voltage of the data line D2. At the time when the MUX transistor is being turned on, Vgs is equal to VON−(−X)=VON+X. This is also higher than the threshold voltage of the transistor and wastes the voltage difference ΔV=X. Thus, this mechanism increases the power consumption.

Similarly, the MUX1:6 pixel charging mechanism also wastes some voltages and increases the power consumption.

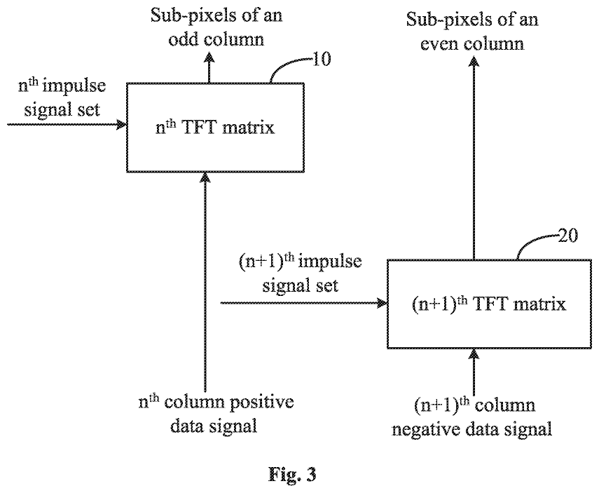

Please refer to FIG. 3. FIG. 3 is a diagram of a column inversion driving circuit according to an embodiment of the present invention. As shown in FIG. 3, a column inversion driving circuit is disclosed. The column inversion driving circuit comprises at least one column inversion driving unit. Here, the n^{th} column inversion unit comprises the n^{th} TFT matrix 10 and the (n+1)^{th} TFT matrix 20. The source of the n^{th} TFT matrix 10 is electrically connected to the n^{th} column positive data signal. The gate of the n^{th} TFT matrix 10 is electrically connected to the n^{th} impulse signal set. The drain of the n^{th} TFT matrix 10 is electrically connected to a corresponding sub-pixel of an odd column. The source of the (n+1)^{th} TFT matrix 20 is electrically connected to the (n+1)^{th} column negative data signal. The gate of the (n+1)^{th} TFT matrix 20 is electrically connected to the (n+1)^{th} impulse signal set. The drain of the (n+1)^{th} TFT matrix 20 is electrically connected to a corresponding sub-pixel of an even column. The voltage level of a logic low of the n^{th} impulse signal set is higher than the turn-off voltage of the n^{th} TFT matrix 10. The voltage level of a logic high of the (n+1)^{th} impulse signal set is lower than the turn-on voltage of the (n+1)^{th} TFT matrix 20.

The number of TFTs in the n^{th} TFT matrix 10 is the same as the number of the impulse signals in the n^{th} impulse signal set and the TFTs in the n^{th} TFT matrix 10 and the impulse signals in the n^{th} impulse signal set have one-to-one correspondence. That is, one impulse signal correspondingly controls one TFT. The number of TFTs in the (n+1)^{th} TFT matrix 20 is the same as the number of the impulse signals in the (n+1)^{th} impulse signal set and the TFTs in the (n+1)^{th} TFT matrix 20 and the impulse signals in the (n+1)^{th} impulse signal set have one-to-one correspondence. That is, one impulse signal correspondingly controls one TFT. Here, each TFT is correspondingly connected to a sub-pixel of an odd column or an even column. It could be understood, when there is a polarity inversion, the n^{th} column positive data signal will become a negative data signal and the (n+1)^{th} column negative data signal will become a positive data signal. Correspondingly, the voltage level of the logic high of the n^{th} impulse signal is lower than the turn-on voltage of the n^{th} TFT matrix 10 and the voltage level of the logic low of the (n+1)^{th} impulse signal is higher than the turn-off voltage of the (n+1)^{th} TFT matrix 10. In this embodiment, the impulse signal has a positive period and a negative period. The high voltage level in the positive period corresponds to the logic high and the low voltage level in the negative period corresponds to the logic low. The voltage level of the logic low is negative and the turn-off voltage is also negative. The voltage level of the logic low is higher than the turn-off voltage. That is, the absolute value of the voltage level of the logic low is less than the absolute value of the turn-off voltage. Therefore, this could reduce the power consumption caused by the voltages. In this embodiment, by controlling the voltage levels of the logic high/low of the impulse signal to be lower on the basis of reliably turning on/off the TFT matrix, the waste of the voltage supplied by the impulse signal for turning on/off the TFT matrix could be reduced and thus the power consumption could be reduced as well.

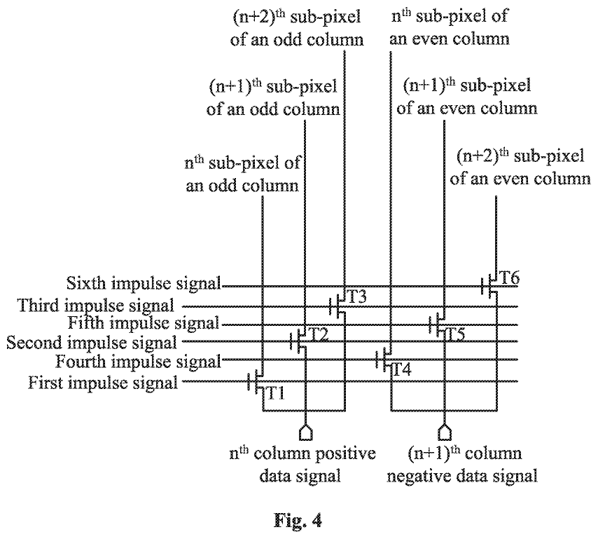

Please refer to FIG. 4. FIG. 4 is a diagram of a column inversion driving circuit according to another embodiment of the present invention. As shown in FIG. 4, the n^{th} TFT matrix comprises a first TFT T1, a second TFT T2, and a third TFT T3. The n^{th} column positive data signal is electrically connected to the source of the first TFT T1, the source of the second TFT T2 and the source of the third TFT T3. The n^{th} impulse signal set is electrically connected to the gate of the first TFT T1, the gate of the second TFT T2 and the gate of the third TFT T3. The drain of the first TFT T1 is electrically connected to the n^{th} sub-pixel of an odd column. The drain of the second TFT T2 is electrically connected to the (n+1)^{th} sub-pixel of an odd column. The drain of the third TFT T3 is electrically connected to the (n+2)^{th} sub-pixel of an odd column.

The above-mentioned n^{th} sub-pixel of an odd column, the (n+1)^{th} sub-pixel of an odd column, and the (n+2)^{th} sub-pixel of an odd column are three adjacent sub-pixels of the odd column.

As shown in FIG. 4, the n^{th} impulse signal set comprises a first impulse signal, a second impulse signal and a third impulse signal. The first impulse signal is electrically connected to the gate of the first TFT T1, the second impulse signal is electrically connected to the gate of the second TFT T2, and the third impulse signal is electrically connected to the gate of the third TFT T3.

The n^{th} impulse signal set correspondingly controls the on/off states of the n^{th} TFT matrix 10.

The voltage level of the logic low of the first impulse signal is higher than the turn-off voltage of the first transistor T1. The voltage level of a logic low of the second impulse signal is higher than the turn-off voltage of the second TFT T2. The voltage level of a logic low of the third impulse signal is higher than the turn-off voltage of the third TFT T3.

When the n^{th} column positive data signal is switched to a negative data signal, the voltage level of the logic high of the impulse signal is lower than the turn-on voltage of the corresponding TFT.

As shown in FIG. 4, the (n+1)^{th} TFT matrix 20 comprises the fourth TFT T4, the fifth TFT T5, and the sixth TFT T6. The (n+1)^{th} column negative data signal is electrically connected to the source of the fourth TFT T4, the source of the fifth TFT T5, and the source of the sixth TFT T6. The (n+1)^{th} impulse signal set is electrically connected to the gate of the fourth TFT T4, the gate of the fifth TFT T5, and the gate of the sixth TFT T6. The drain of the fourth TFT T4 is electrically connected to the n^{th} sub-pixel of an even column. The drain of the fifth TFT T5 is electrically connected to the (n+1)^{th} sub-pixel of an even column. The drain of the sixth TFT T6 is electrically connected to the (n+2)^{th} sub-pixel of an even column.

The above-mentioned n^{th} sub-pixel of an odd column, the (n+1)^{th} sub-pixel of an odd column, and the (n+2)^{th} sub-pixel of an odd column are three adjacent sub-pixels of the odd column.

As shown in FIG. 4, the (n+1)^{th} impulse signal set comprises a fourth impulse signal, a fifth impulse signal and a sixth impulse signal. The fourth impulse signal is electrically connected to the gate of the fourth TFT T4. The fifth impulse signal is electrically connected to the gate of the fifth TFT T5. The sixth impulse signal is electrically connected to the gate of the sixth TFT T6.

The voltage level of the logic high of the fourth impulse signal is lower than the turn-on voltage of the fourth TFT T4. The voltage level of the logic high of the fifth impulse signal is lower than the turn-on voltage of the fifth TFT T5. The voltage level of the logic high of the sixth impulse signal is lower than the turn-on voltage of the sixth TFT T6.

When the (n+1)^{th} negative data signal becomes a positive data signal, correspondingly, the voltage level of the logic low of the impulse signal is higher than the turn-off voltage of the corresponding TFT.

The n^{th} TFT matrix 10 comprises a plurality of n-channel TFTs. But this is not a limitation of the present invention. Please note, the n^{th} TFT matrix 10 could comprise a plurality of p-channel TFTs. In this embodiment, the voltage levels of the logic low and logic high of the impulse signal need to be adjusted accordingly to meet the needs of turning on/off the TFTs and to avoid the waste of voltages for turning on/off the TFTs.

The (n+1)^{th} TFT matrix 20 comprises a plurality of n-channel TFTs. Similarly, this is not a limitation of the present invention. Please note, the (n+1)^{th} TFT matrix 20 could comprise a plurality of p-channel TFTs. In this embodiment, the voltage levels of the logic low and logic high of the impulse signal need to be adjusted accordingly to meet the needs of turning on/off the TFTs and to avoid the waste of voltages for turning on/off the TFTs.

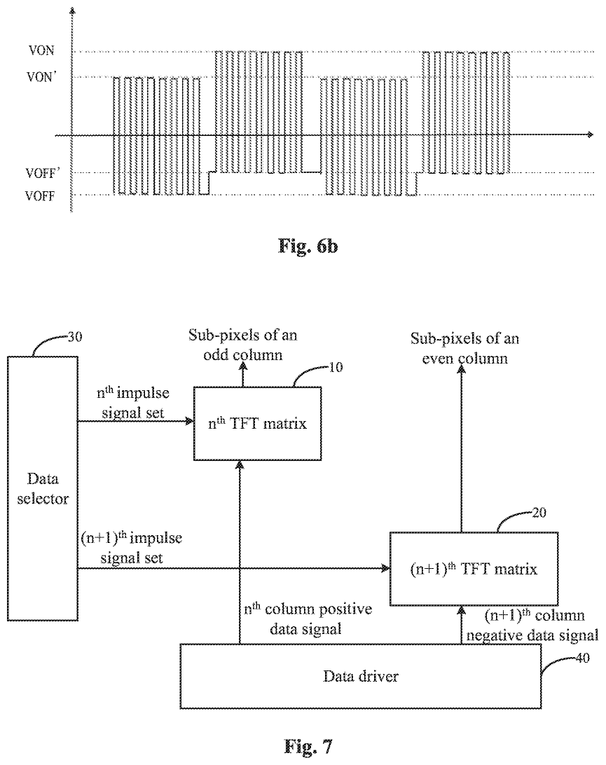

Please refer to FIG. 7. FIG. 7 is a diagram of a display panel according to an embodiment of the present invention. As shown in FIG. 7, a display panel is disclosed. The display panel comprises a data driver 40, a data selector 30 and a column inversion driving circuit of any of the above-mentioned embodiments. The data driver 40 is used to provide the n^{th} column positive data signal and the (n+1)^{th} column negative data signal. The data selector 30 is used to provide the n^{th} impulse signal set and the (n+1)^{th} impulse signal set.

The column inversion driving circuit has an advantage of reducing voltage loss. The display panel also has an advantage of reducing the power consumption.

The display panel further comprises a timing controller. The timing controller is used to control the data driver 40 and the data selector 30 to output corresponding signals at the right timings to better implement the above-mentioned embodiments.

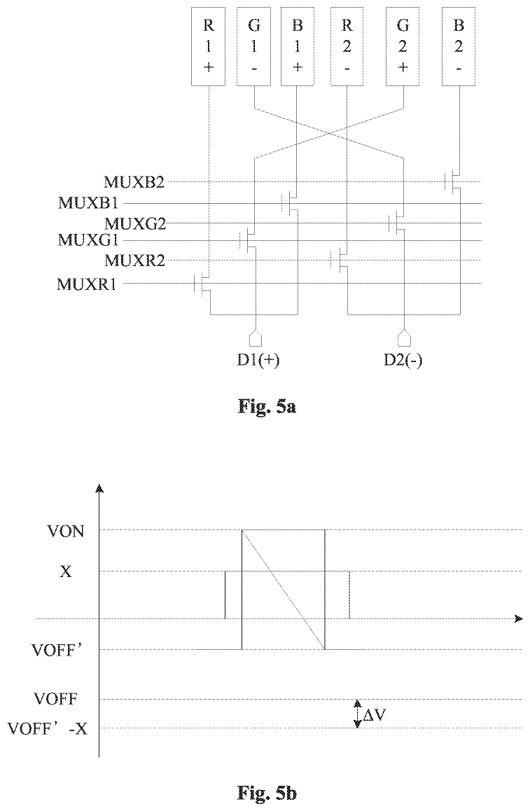

The column inversion driving circuit could reduce the voltage waste and power consumption. The related driving method is as shown in FIG. 5a. Another MUX control signal set, including MUXR1, MUXG1, MUXB1, MUXR2, MUXG2 and MUXB2, is added to the conventional MUX1:3 control circuit. Furthermore, the positive data signals and the negative data signals are separately controlled. MUXR1, MUXG1, MUXB1 orderly control the output of the data signal D1. MUXR2, MUXG2, MUXB2 orderly control the output of the data signal D2.

As shown in FIG. 5b, for the positive data voltage D1, MUX1 signal, including MUXR1, MUXG1 and MUXB1, is determined to be periodically changed between the turn-on voltage VON and VOFF′. Here, the absolute value of VOFF′ is lower than the absolute value of turn-off voltage VOFF. When the transistor controlled by MUX1 is being turned on, Vgs is equal to VON. When the transistor controlled by MUX1 is being turned off, Vgs is the absolute value of VOFF′−X. At this time, the voltage waste ΔV is equal to the absolute value of VOFF′−X subtracting the absolute value of VOFF. This voltage waste ΔV is less than X. Thus, the voltage waste is reduced.

As shown in FIG. 5c, for the negative data voltage D2, MUX2 signal, including MUXR2, MUXG2 and MUXB2, is determined to be periodically changed between VON′ and the turn-off voltage VOFF. Here, the absolute value of VON′ is lower than the absolute value of turn-on voltage VON. When the transistor controlled by MUX2 is being turned on, Vgs is equal to VON′+X. This voltage waste ΔV is also less than X. Thus, the voltage waste is reduced.

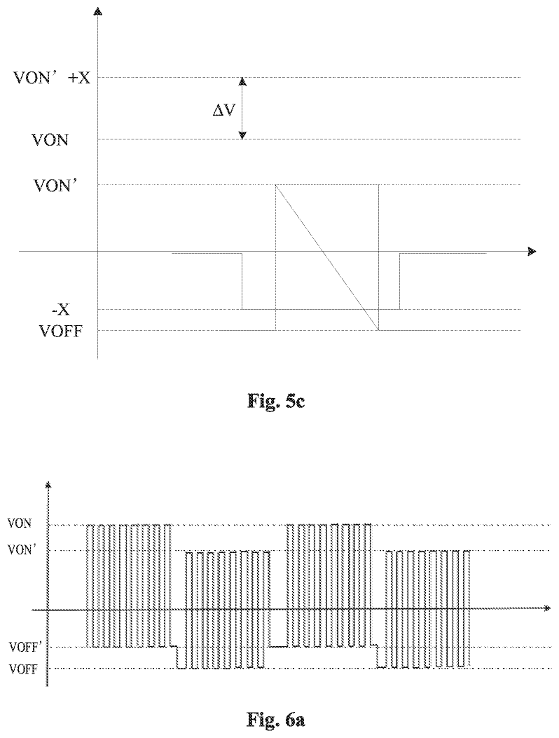

As shown in FIG. 6a and FIG. 6b, when the display panel is refreshed to a next frame, the polarities of the data line D1 and the data line D2 are inversed. The data line D1 corresponds to a negative voltage and the data line D2 corresponds to a positive voltage. At this time, the MUX1 signal periodically changes between VON′ and VOFF and MUX2 signal periodically changes between VON and VOFF′. This reduces the voltage waste and enormously reduces the power consumption. Similarly, for the MUX1:n, the number of MUX signals becomes double for respectively controlling the positive data voltage and the negative data voltage. In addition, the voltage values also dynamically changes according to the frames.

The voltage level of VON′ could be implemented as a lower positive voltage in the current power architecture. For example, the input voltage of a power IC in a notebook is 3.3V. The input voltage of a timing controller is 1.1V or 1.8V. These voltages could be used as VON′. Similarly, the voltage level of VOFF′ could be implemented as a higher negative voltage in the current power architecture. There is no need to add another voltage converting module. This ensures that there will be other power consumption caused by any additional element.

Above are embodiments of the present invention, which does not limit the scope of the present invention. Any modifications, equivalent replacements or improvements within the spirit and principles of the embodiment described above should be covered by the protected scope of the invention.

1. A column inversion driving circuit, comprising at least one column inversion driving unit, wherein a n^{th} column inversion unit comprises a n^{th} TFT matrix and a (n+1)^{th} TFT matrix;
wherein a source of the n^{th} TFT matrix is electrically connected to a n^{th} column positive data signal, a gate of the n^{th} TFT matrix is electrically connected to a n^{th} impulse signal set, and a drain of the n^{th} TFT matrix is electrically connected to a corresponding sub-pixel of an odd column;
wherein a source of the (n+1)^{th} TFT matrix is electrically connected to a (n+1)^{th} column negative data signal, a gate of the (n+1)^{th} TFT matrix is electrically connected to a (n+1)^{th} impulse signal set, and a drain of the (n+1)^{th} TFT matrix is electrically connected to a corresponding sub-pixel of an even column; and
wherein a voltage level of a logic low of the n^{th} impulse signal set is higher than a turn-off voltage of the n^{th} TFT matrix, a voltage level of a logic high of the (n+1)^{th} impulse signal set is lower than a turn-on voltage of the (n+1)^{th} TFT matrix, and the (n+1)^{th} TFT matrix comprises a plurality of n-channel TFTs.

2. The column inversion driving circuit of claim 1, wherein the n^{th} TFT matrix comprises a first TFT, a second TFT, and a third TFT;
wherein the n^{th} column positive data signal is electrically connected to a source of the first TFT, a source of the second TFT and a source of the third TFT; the n^{th} impulse signal set is electrically connected to a gate of the first TFT, a gate of the second TFT and a gate of the third TFT; a drain of the first TFT is electrically connected to a n^{th} sub-pixel of an odd column; a drain of the second TFT is electrically connected to a (n+1)^{th} sub-pixel of an odd column, and a drain of the third TFT is electrically connected to a (n+2)^{th} sub-pixel of an odd column.

3. The column inversion driving circuit of claim 2, wherein the n^{th} impulse signal set comprises a first impulse signal, a second impulse signal and a third impulse signal;
wherein the first impulse signal is electrically connected to the gate of the first TFT, the second impulse signal is electrically connected to the gate of the second TFT, and the third impulse signal is electrically connected to the gate of the third TFT.

4. The column inversion driving circuit of claim 3, wherein a voltage level of a logic low of the first impulse signal is higher than a turn-off voltage of the first TFT, a voltage level of a logic low of the second impulse signal is higher than a turn-off voltage of the second TFT, and a voltage level of a logic low of the third impulse signal is higher than a turn-off voltage of the third TFT.

5. The column inversion driving circuit of claim 1, wherein the (n+1)^{th} TFT matrix comprises a fourth TFT, a fifth TFT, and a sixth TFT;
wherein the (n+1)^{th} column negative data signal is electrically connected to a source of the fourth TFT, a source of the fifth TFT, and a source of the sixth TFT; the (n+1)^{th} impulse signal set is electrically connected to a gate of the fourth TFT, a gate of the fifth TFT, and a gate of the sixth TFT; a drain of the fourth TFT is electrically connected to a n^{th} sub-pixel of an even column; a drain of the fifth TFT is electrically connected to a (n+1)^{th} sub-pixel of an even column; and a drain of the sixth TFT is electrically connected to a (n+2)^{th} sub-pixel of an even column.

6. The column inversion driving circuit of claim 5, wherein the (n+1)^{th} impulse signal set comprises a fourth impulse signal, a fifth impulse signal and a sixth impulse signal;
wherein the fourth impulse signal is electrically connected to the gate of the fourth TFT, the fifth impulse signal is electrically connected to the gate of the fifth TFT, and the sixth impulse signal is electrically connected to the gate of the sixth TFT.

7. The column inversion driving circuit of claim 6, wherein a voltage level of a logic high of the fourth impulse signal is lower than a turn-on voltage of the fourth TFT, a voltage level of a logic high of the fifth impulse signal is lower than a turn-on voltage of the fifth TFT, and a voltage level of a logic high of the sixth impulse signal is lower than a turn-on voltage of the sixth TFT.

8. The column inversion driving circuit of claim 1, wherein the n^{th} TFT matrix comprises a plurality of n-channel TFTs.

9. A column inversion driving circuit, comprising at least one column inversion driving unit, wherein a n^{th} column inversion unit comprises a nth TFT matrix and a (n+1)th TFT matrix;
wherein a source of the n^{th} TFT matrix is electrically connected to a n^{th} column positive data signal, a gate of the n^{th} TFT matrix is electrically connected to a n^{th} impulse signal set, and a drain of the n^{th} TFT matrix is electrically connected to a corresponding sub-pixel of an odd column;
wherein a source of the (n+1)^{th} TFT matrix is electrically connected to a (n+1)^{th} column negative data signal, a gate of the (n+1)^{th} TFT matrix is electrically connected to a (n+1)^{th} impulse signal set, and a drain of the (n+1)^{th} TFT matrix is electrically connected to a corresponding sub-pixel of an even column; and
wherein a voltage level of a logic low of the n^{th} impulse signal set is higher than a turn-off voltage of the n^{th} TFT matrix, and a voltage level of a logic high of the (n+1)^{th} impulse signal set is lower than a turn-on voltage of the (n+1)^{th} TFT matrix.

10. The column inversion driving circuit of claim 9, wherein the n^{th} TFT matrix comprises a first TFT, a second TFT, and a third TFT;
wherein the n^{th} column positive data signal is electrically connected to a source of the first TFT, a source of the second TFT and a source of the third TFT; the n^{th} impulse signal set is electrically connected to a gate of the first TFT, a gate of the second TFT and a gate of the third TFT; a drain of the first TFT is electrically connected to a n^{th} sub-pixel of an odd column; a drain of the second TFT is electrically connected to a (n+1)^{th} sub-pixel of an odd column, and a drain of the third TFT is electrically connected to a (n+2)^{th} sub-pixel of an odd column.

11. The column inversion driving circuit of claim 10, wherein the n^{th} impulse signal set comprises a first impulse signal, a second impulse signal and a third impulse signal;
wherein the first impulse signal is electrically connected to the gate of the first TFT, the second impulse signal is electrically connected to the gate of the second TFT, and the third impulse signal is electrically connected to the gate of the third TFT.

12. The column inversion driving circuit of claim 11, wherein a voltage level of a logic low of the first impulse signal is higher than a turn-off voltage of the first TFT, a voltage level of a logic low of the second impulse signal is higher than a turn-off voltage of the second TFT, and a voltage level of a logic low of the third impulse signal is higher than a turn-off voltage of the third TFT.

13. The column inversion driving circuit of claim 9, wherein the (n+1)^{th} TFT matrix comprises a fourth TFT, a fifth TFT, and a sixth TFT;
wherein the (n+1)^{th} column negative data signal is electrically connected to a source of the fourth TFT, a source of the fifth TFT, and a source of the sixth TFT; the (n+1)^{th} impulse signal set is electrically connected to a gate of the fourth TFT, a gate of the fifth TFT, and a gate of the sixth TFT; a drain of the fourth TFT is electrically connected to a n^{th} sub-pixel of an even column; a drain of the fifth TFT is electrically connected to a (n+1)^{th} sub-pixel of an even column; and a drain of the sixth TFT is electrically connected to a (n+2)^{th} sub-pixel of an even column.

14. The column inversion driving circuit of claim 13, wherein the (n+1)^{th} impulse signal set comprises a fourth impulse signal, a fifth impulse signal and a sixth impulse signal;
wherein the fourth impulse signal is electrically connected to the gate of the fourth TFT, the fifth impulse signal is electrically connected to the gate of the fifth TFT, and the sixth impulse signal is electrically connected to the gate of the sixth TFT.

15. The column inversion driving circuit of claim 14, wherein a voltage level of a logic high of the fourth impulse signal is lower than a turn-on voltage of the fourth TFT, a voltage level of a logic high of the fifth impulse signal is lower than a turn-on voltage of the fifth TFT, and a voltage level of a logic high of the sixth impulse signal is lower than a turn-on voltage of the sixth TFT.

16. The column inversion driving circuit of claim 9, wherein the n^{th} TFT matrix comprises a plurality of n-channel TFTs.

17. A display panel, comprising:
a data driver, providing an nth column positive data signal and an (n+1)th column negative data signal;
a data selector, providing an nth impulse signal set and an (n+1)th impulse signal set; and
a column inversion driving circuit, comprising at least one column inversion driving unit, wherein a nth column inversion unit comprises a nth TFT matrix and a (n+1)th TFT matrix;
wherein a source of the nth TFT matrix is electrically connected to the nth column positive data signal, a gate of the nth TFT matrix is electrically connected to the nth impulse signal set, and a drain of the nth TFT matrix is electrically connected to a corresponding sub-pixel of an odd column;
wherein a source of the (n+1)th TFT matrix is electrically connected to the (n+1)th column negative data signal, a gate of the (n+1)th TFT matrix is electrically connected to the (n+1)th impulse signal set, and a drain of the (n+1)th TFT matrix is electrically connected to a corresponding sub-pixel of an even column; and
wherein a voltage level of a logic low of the nth impulse signal set is higher than a turn-off voltage of the nth TFT matrix, a voltage level of a logic high of the (n+1)th impulse signal set is lower than a turn-on voltage of the (n+1)th TFT matrix, and the (n+1)th TFT matrix comprises a plurality of n-channel TFTs.
